(19) United States
(12) Patent Application Publication
(10) Pub. No.: US 2010/0152866 A1
(43) Pub. Date: Jun. 17, 2010

(54) INFORMATION PROCESSING APPARATUS, INFORMATION PROCESSING METHOD AND COMPUTER-READABLE MEDIUM HAVING AN INFORMATION PROCESSING PROGRAM

(75) Inventor: Jinsuke NAKAI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, KAWASAKI (JP)

(21) Appl. No.: 12/638,211

(22) Filed: Dec. 15, 2009

(30) Foreign Application Priority Data
Dec. 16, 2008 (JP) 2008-320183

(51) Int. Cl. G05B 19/042

(52) U.S. Cl. 700/4; 700/7

(57) ABSTRACT

An information processing system includes an information processing apparatus and a system controller. The information processing apparatus includes an information storage that stores function specifying information identifying a processing function on a second processor corresponding to a process which is to be executed by a first processor and a information transfer section that transfers a processing information including the function specifying information to the system controller. The system controller includes a function storage that stores the processing function corresponding to the process which is included in the processes to be executed by the first processor as a provided function and a result transfer section that executes a process using the processing function and corresponding to the function specifying information included in the processing information and that transfers a result of execution of the process to the information processing apparatus.

### CROSS-REFERENCE TO RELATED APPLICATIONS

This application is based upon and claims priority to prior Japanese Patent Application No. 2008-320183 filed on Dec. 16, 2008 in the Japan Patent Office, the entire contents of which are incorporated herein by reference.

### BACKGROUND

1. Field

Embodiment(s) described herein relate to an information processing apparatus, an information processing method and a computer-readable medium having an information processing program.

2. Description of the Related Art

Recently, an information processing apparatus and an information processing system include multiprocessors that have been generally used in order to execute large scale information processing. In the field of existing information processing apparatus and information processing system of the above mentioned type, there exists a technique of adopting a sub system such as a system control device that operates independently of a main system serving as an information processing apparatus main body for executing processes involving general business processing. The sub system mainly handles control processing executed in order to cope with a failure occurred in the main system and a service processor (SVP) may be given as a specific example thereof.

Japanese Laid-open Patent Publication No. 2006-24124 discusses a typical information processing system.

### SUMMARY

According to an embodiment, an information processing system includes an information processing apparatus and a system controller, wherein the information processing apparatus includes a information storage that stores function specifying information specifying a processing function on a second processor corresponding to a process which is to be executed by a first processor and a information transfer section that transfers a processing information including the function specifying information to the system controller, and the system controller includes a function storage that stores the processing function corresponding to the process which is included in the processes to be executed by the first processor as a provided function and a result transfer section that executes a process using a processing function included in the processing functions as the provided functions and corresponding to the function specifying information included in the processing information and that transfers a result of execution of the process to the information processing apparatus.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of information defined between systems according to an embodiment;

FIG. 2 is a diagram illustrating operations of an information processing apparatus according to an embodiment;

FIG. 3 is a diagram illustrating an example of an information processing apparatus according to an embodiment;

FIG. 4 is a diagram illustrating an example of a processing unit according to an embodiment;

FIG. 5 is a diagram illustrating an information processing apparatus according to an embodiment;

FIG. 6 is a diagram illustrating an information processing apparatus according to an embodiment;

FIG. 7 is a diagram illustrating an information processing apparatus according to an embodiment;

FIG. 8 is a diagram illustrating processes executed by an information processing apparatus according to an embodiment;

FIG. 9 is a diagram illustrating an advantageous effect obtained by an information processing apparatus according to an embodiment;

FIG. 10 is a diagram illustrating an advantageous effect obtained by an information processing apparatus according to an embodiment;

FIG. 11 is a diagram illustrating an advantageous effect obtained by an information processing apparatus according to an embodiment;

FIG. 12 is a diagram illustrating an information processing apparatus according to an embodiment;

FIG. 13 is a diagram illustrating an information processing apparatus according to an embodiment;

FIG. 14 is a diagram illustrating an example of information defined between systems according to an embodiment;

FIG. 15 is a diagram illustrating an information processing apparatus according to an embodiment;

FIG. 16 is a diagram illustrating an information processing apparatus according to an embodiment; and

FIG. 17 is a diagram illustrating examples of function(s) which an information processing apparatus includes in the embodiments of the present invention.

### DETAILED DESCRIPTION OF THE PREFERRED EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Next, embodiments of an information processing apparatus, an information processing method and a computer-readable medium having an information processing program will be described in detail with reference to the accompanying drawings.

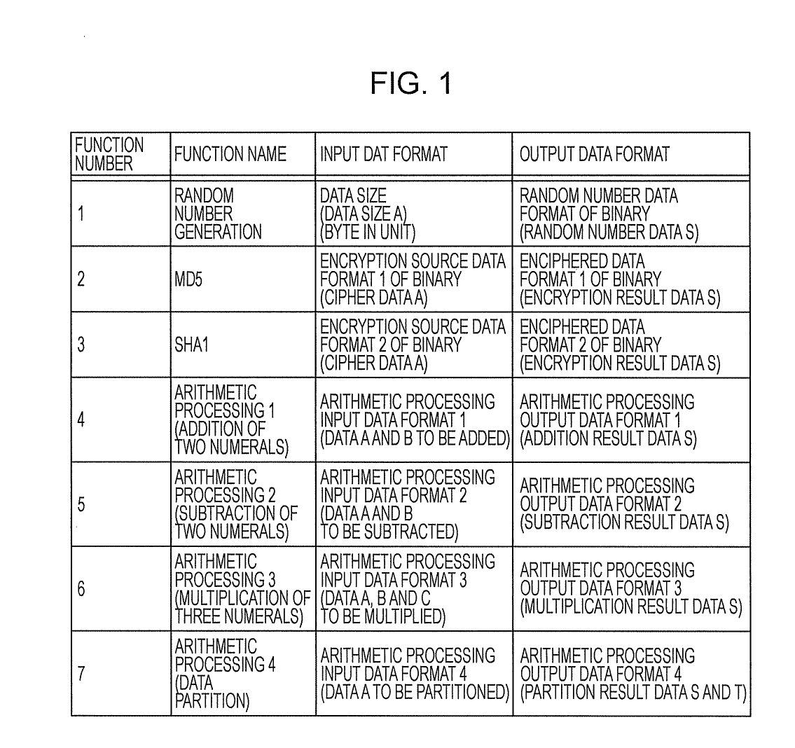

FIG. 1 is a diagram illustrating an example of information defined between systems according to an embodiment. The information processing apparatus according to an embodiment includes a main system for executing processes involving general business processing and a sub system for executing control processing coping with a failure occurred in the main system.

The information processing apparatus according to an embodiment defines a function number used to specify a processing function executed on the sub system side and data formats corresponding to a process including processes executed on the main system which is requested to execute from the main system to the sub system. For example, function number “1” corresponding to a random number generation process which is a processing function of the sub system and “Data Size A” indicative of the input data format and “Random Number Data S” indicative of the output data format used upon the random number generation are defined. While specific examples of processes are illustrated in FIG. 1, the present invention is not limited thereto.

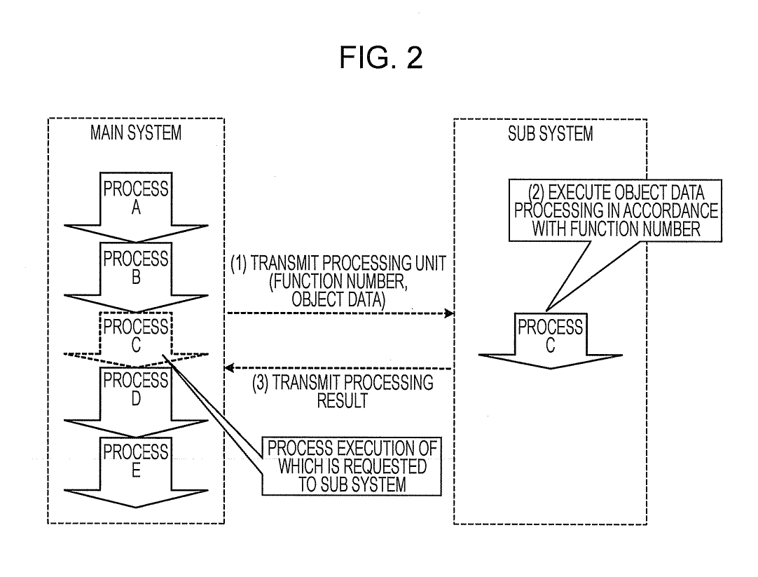

Next, the information processing apparatus according to an embodiment will be briefly described with reference to FIG. 2. The main system transmits, to the sub system, data pertaining to a processing unit as a processing information which is data including a function number used to specify a processing function on the sub system corresponding to a process (for example, a process C) is to be requested to execute from the main system to the sub system (see (1) in the FIG. 2). The sub system executes the process C (for example, the random number generation) corresponding to the function number included in the processing unit received from the main system (see (2) in the FIG. 2) and transmits a result of execution of the process (hereinafter, referred to as a processing result) to the main system (see (3) in the

FIG. 2). FIG. 2 is a diagram illustrating operation(s) of the information processing apparatus according to an embodiment.

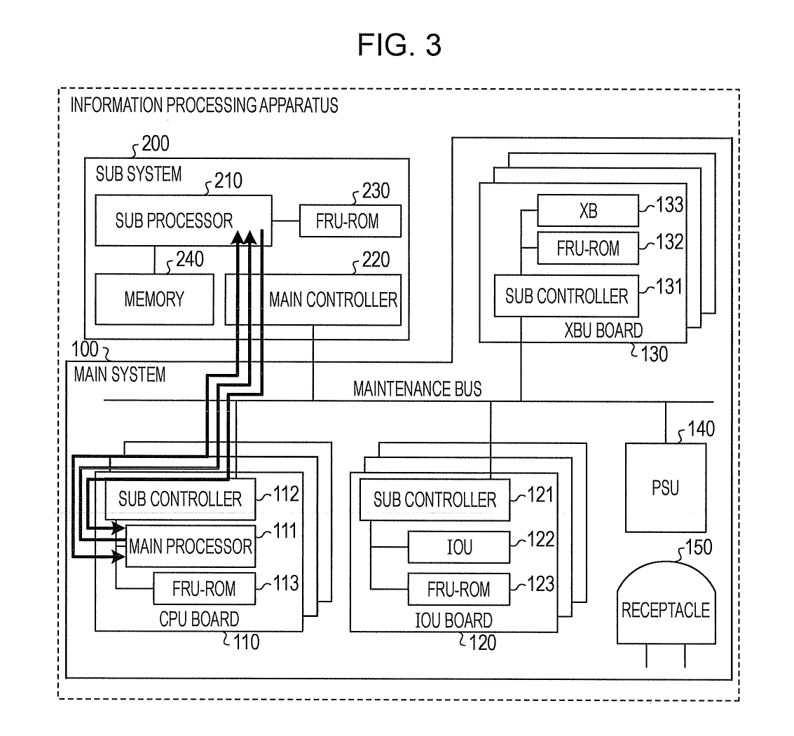

FIG. 3 is a diagram illustrating an example of the information processing apparatus according to an embodiment. As illustrated in the FIG. 3, the information processing apparatus according to an embodiment includes a main system 100 and a sub system 200. In the following, parts included in the information processing apparatus according to an embodiment is described in detail.

The main system 100 is a main body of the information processing apparatus. The main system 100 has a CPU (Central Processing Unit) board 110, an IOU (Input Output Unit) board 120, an XBU (Crossbar Unit) board 130, a PSU (Power Supply Unit) 140 and a receptacle 150. The CPU board 110 has a main processor 111 serving as a first arithmetic processing device, a sub controller 112 and an FRU-ROM (Field Replaceable Unit Read Only Memory) 113.

The FRU-ROM 113 is a component of the system designed to be replaced with another one in the field without sending the system back to a factory or a repair shop.

The main processor 111 serving as the first arithmetic processing device has an internal memory for storing a predetermined control program, programs defining procedures of various processes and data, and executes on its own initiative various processes in accordance with the programs stored in the internal memory. The main processor 111 stores an application program in the internal memory, and the application program includes a processing unit which is data including a function number and the like used to specify a processing function executed on the sub system, and corresponding to a process which is to be requested to execute from the main system to the sub system 200 serving as a system control device. Then, the main processor 111 transmits information of the processing unit included in the application program read out of the internal memory to the sub system 200 via the sub controller 112, and the main processor 111 receives a processing result from the sub system 200.

As illustrated in FIG. 3, the sub system 200 serving as the system control device has a sub processor 210 serving as a second arithmetic processing device, a main controller 220, an FRU-ROM 230 and a memory 240.

The FRU-ROM 230 is a component of the system designed to be replaced with another one in the field without sending the system back to a factory or a repair shop.

The memory 240 stores a predetermined controlling program, programs defining procedures of various processes and data as data utilized in the sub processor 210.

The sub processor 210 serving as the second arithmetic processing device reads the predetermined controlling program, the program defining the procedures of various processes and the data out of the memory 240 and executes various processes in accordance therewith. The sub processor 210 executes a process execution of which has been entrusted from the main system 100 side using a processing function corresponding to the process execution of which has been entrusted from the main system side with reference to a table indicative of functions provided from the sub system 200 (hereinafter, referred to as a sub system providing function table, see FIG. 1, for example) included in a function publicizing module which is resident in the sub system 200 and transmits the processing result to the main system 100.

In the sub system providing function table included in the function publicizing module, for example, the following data is defined in advance as functions which are provided from the sub system 200 to the main system 100. For example, the function number “1” corresponding to the random number generation which is a processing function dedicated to the sub system, and “DATA SIZE A” indicative of the input data format and “RANDOM NUMBER DATA S” indicative of the data output format used upon random number generation are defined the sub system providing function table in advance in a correlated state (see FIG. 1). Likewise, the function number “4” corresponding to arithmetic processing 1 (addition of two numerals) which is a processing function of the sub system, “ARITHMETIC PROCESSING INPUT DATA FORMAT 1” indicative of the input data format used upon execution of arithmetic processing and “ARITHMETIC PROCESSING OUTPUT DATA FORMAT 1” indicative of the output data format used at the completion of execution of the arithmetic processing are defined in the sub system providing function table in advance in a correlated state (see FIG. 1).

Next, operations performed between the main system 100 and the sub system 200 in the case that an application program is executed by the main system 100 will be described. The main system 100 (actually, the application program (which is described in detail below) which is being executed by the main processor 111) confirms whether execution of a process may be requested from the main system 100 to the sub system 200 (actually, the function publicizing module (which is described in detail below) which is being executed by the sub system).

The sub system 200 sends a response to the main system 100 as to whether the request for execution of the process concerned is accepted (or permitted). In the case that a load exerted on the sub processor 210 is high, for example, upon system starting sequence, the sub system 200 sends a response that the request for execution of the process is “refused” to the main system 100. While in the case that the load on the sub processor 210 is low, a response that the request for execution of the process is “permitted” is sent to the main system 100.

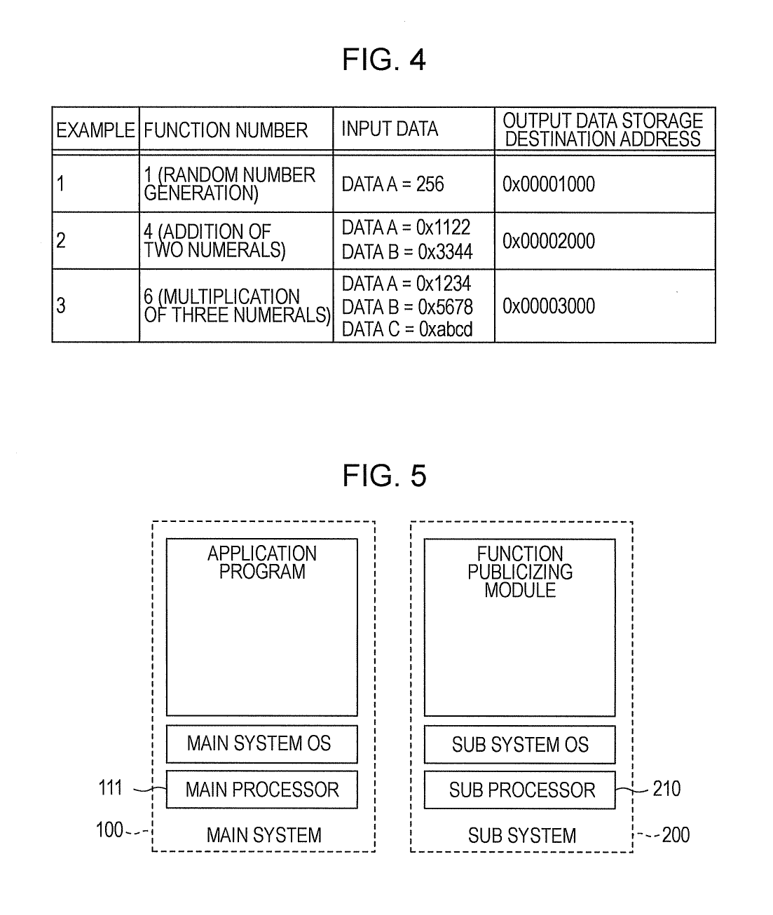

The main system executes the following processes in accordance with the response to the request for execution of the process from the sub system 200. Specifically, in the case that the response indicates the request for execution of the process is “refused” has been received from the sub system 200, the main system 100 executes the process by itself. On the other hand, in the case indicates the response that the request for execution of the process is “permitted” has been received from the sub system 200, the main system 100 transmits information pertaining to a processing unit included in an application program which is being currently executed by the main processor 111 to the sub system 200 via the sub controller 112. This processing unit is data including a function number of a process execution of which is to be requested from the main system 100 to the sub system 200, input data indicative of data on a processing object concerned and an address of the main memory on the main system 100 which is designated as the address of the storage destination of output data which has been processed on the sub system 200 side, for example. FIG. 4 illustrates an example of processing units according to an embodiment.

The sub system 200 which has received information of the processing unit concerned from the main system 100 specifies a processing function corresponding to the function number included in the processing unit with reference to the sub system providing function table included in the function publicizing module which is resident in the sub system 200. Then, the sub system 200 executes the process of the input data included in the processing unit received from the main system 100 by using the specified processing function and generates processed data.

The sub system 200 transmits the processed data generated in accordance with the request for execution of the process from the main system 100 to the main system 100 based on the storage destination address included in the processing unit received from the main system 100. The processed data which has been transmitted from the sub system 200 is transferred by DMA (Direct Memory Access) to the main memory of the main processor, and an interrupt signal indicative of completion of the process is input from the sub system 200 into the main system 100 at the completion of processed data transfer.

The main system 100 executes succeeding processes by utilizing the processing result received from the sub system 200.

In the main system 100 and the sub system 200, actually, programs execute processes as described below. That is, as illustrated in FIG. 5, actually, “APPLICATION PROGRAM” which is being executed by the main processor 111 of the main system 100 sends a request for execution of a process from the main system 100 to the sub system 200. The application program is programmed to include therein “PROCESSING UNIT” which is data included the function number and the like of the process execution of which is to be requested to the sub system 200 and is supposed to be used as software for execution of general technological calculations and business calculations.

In addition, “FUNCTION PUBLICIZING MODULE” which is resident in the sub processor 210 of the sub system 200 is a program in accordance with which judgment as to permission or refusal of the request for execution of the process is performed and the process execution of which has been requested is executed on the sub system 200 as illustrated in FIG. 5. The function publicizing module includes therein “SUB SYSTEM PROVIDING FUNCTION TABLE” (for example, see FIG. 1) used to specify the processing function corresponding to the function number included in the processing unit received from the main system 100. FIG. 5 is a diagram illustrating an information processing apparatus according to an embodiment.

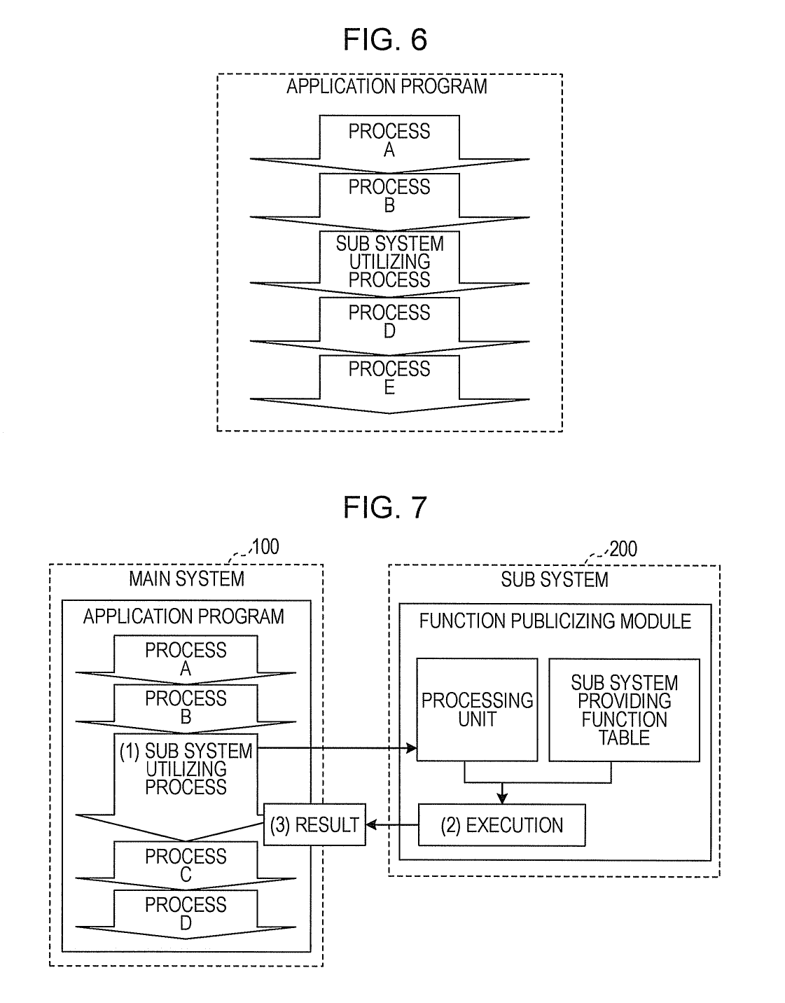

It is supposed that the processing unit which is data used to specify “SUB SYSTEM UTILIZING PROCESS” has been registered in advance in “APPLICATION PROGRAM” which is being executed by the main processor 111 of the main system 100, for example, as illustrated in FIG. 6. It is also supposed that which function is utilized as which timing may be freely determined upon preparation of each application program. FIG. 6 is a diagram illustrating an information processing apparatus according to an embodiment.

As illustrated in FIG. 7, while the application program is being executed by the main processor 111 of the main system 100, “PROCESSING UNIT” is transmitted to the function publicizing module by executing “SUB SYSTEM UTILIZING PROCESS” (see (1) in FIG. 7). The function publicizing module which is being executed by the sub processor 210 of the sub system 200 executes the process using the processing function corresponding to “PROCESSING UNIT” which has been transferred from the main system 100 (see (2) in FIG. 7). At the completion of execution of the process, the function publicizing module transmits the processing result to the main system 100 (see (3) in FIG. 7). FIG. 7 is a diagram illustrating an information processing apparatus according to an embodiment.

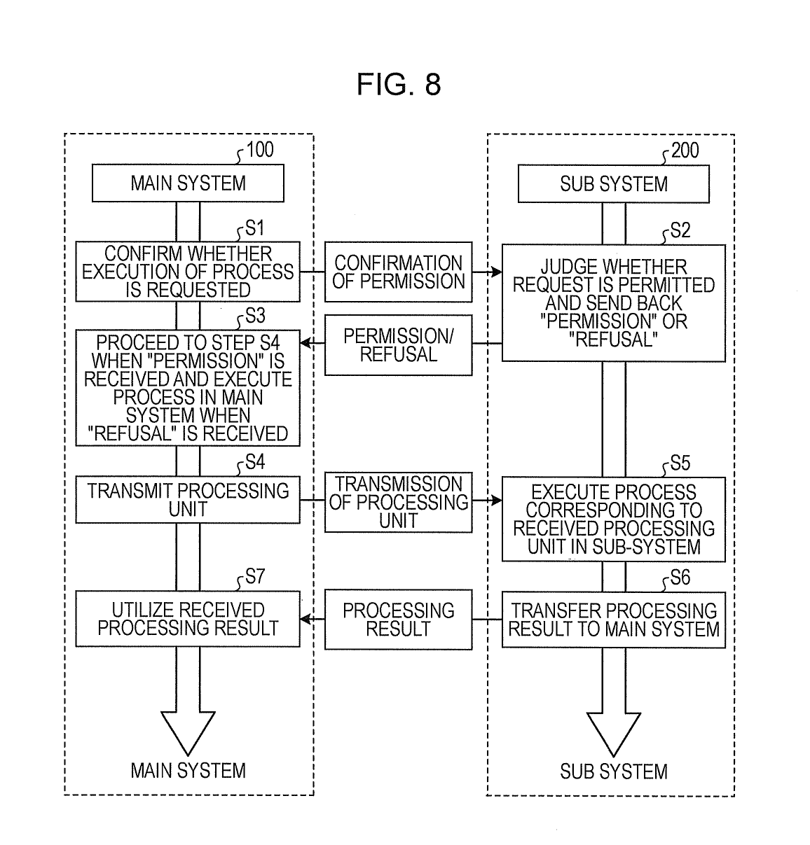

FIG. 8 is a diagram illustrating the processes executed by the information processing apparatus according to an embodiment. In the case that the situation turns to a state in which “SUB SYSTEM UTILIZING PROCESS” is to be executed while the application program is being executed by the main processor 111 of the main system 100, the processes as follows are executed. As illustrated in FIG. 8, the main system 100 confirms whether execution of the process may be requested to the sub system 200 (operation S1).

The sub system 200 judges whether the request for execution of the process is accepted (permitted) and sends a response to the main system 100 (operation S2). In the case that the load on the sub processor 210 is temporarily increased upon starting up the system, for example, the sub system 200 sends a response that the request for execution of the process is “refused” to the main system 100, while in the case that the load on the sub processor is low, the sub system 200 sends a response that the request for execution of the process is “permitted” to the main system 100. That is, the sub system 200 sends the response that the request for execution of the process is “permitted” or “refused” to the main system 100 in accordance with the load exerted on its sub processor.

The main system 100 executes the processes as follows in accordance with the response to the request for execution of the process received from the sub system 200. Specifically, in the case that the response that the request for execution of the process is “refused” has been received from the sub system 200, the main system 100 executes the process by itself (operation S3). In the case that the response that the request for execution of the process is “permitted” has been received from the sub system 200, the process proceeds to operation S4 and the processing unit included in the application program which is being executed by the main processor 111 is transmitted to the sub system 200 (operation S4). The processing unit is data included the function number of the process execution of which is to be requested to the sub system 200, the input data indicative of the processing object data and the address of the main memory on the main system 100 which is designated as the address of the storage destination of the output data which has been processed on the sub system 200 (see FIG. 4).

The sub system 200 which has received the processing unit including the function number and the like of the process execution of which has been requested from the main system 100 specifies the processing function corresponding to the function number included in the processing unit with reference to the sub system providing function table included in the function publicizing module which is resident in the sub system 200 and executes processing of the input data by using the specified processing function (operation S5). The sub system 200 transmits a processing result to the main system 100 (operation S6).

The main system 100 executes the succeeding processes by utilizing the processing result received from the sub system 200 (operation S7).

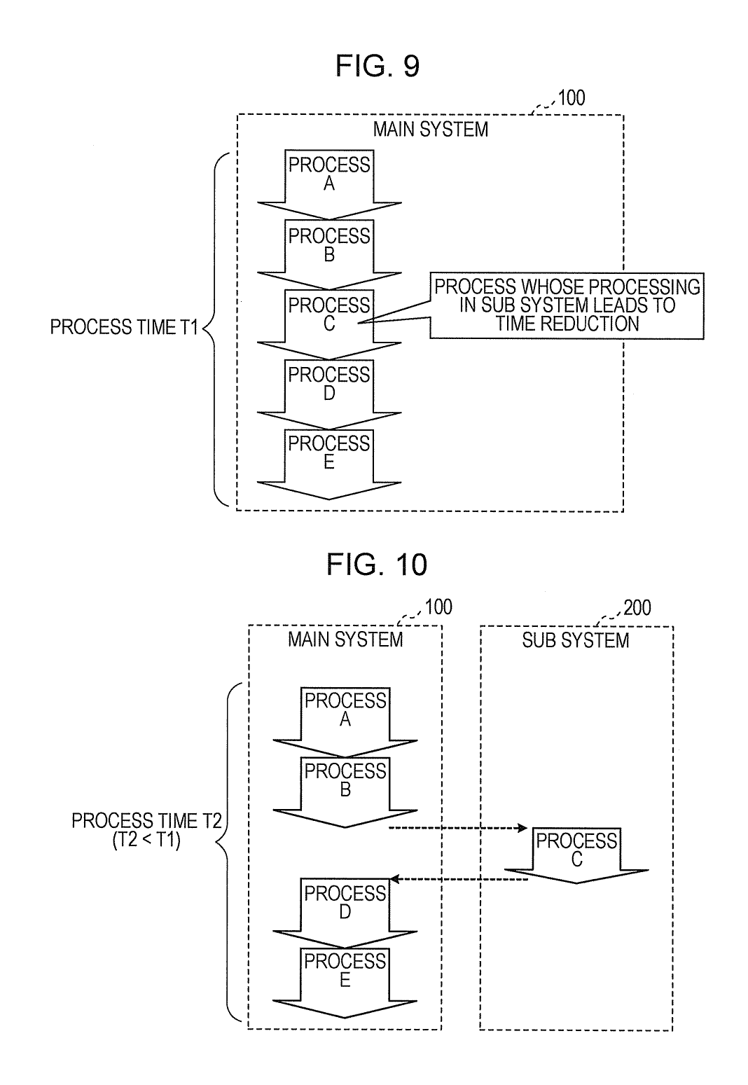

According to an embodiment, effects as described below are obtained. It is supposed that processes including a process C processing time of which is relatively reduced when the process C is executed on the sub system 200 are executed by the main system 100, for example, as illustrated in FIG. 9. In the above mentioned situation, if the execution of the process C is entrusted to the sub system 200 and its processing result is utilized on the main system 100, for example, as illustrated in FIG. 10, a total processing time of the information processing apparatus will be reduced (T2<T1).

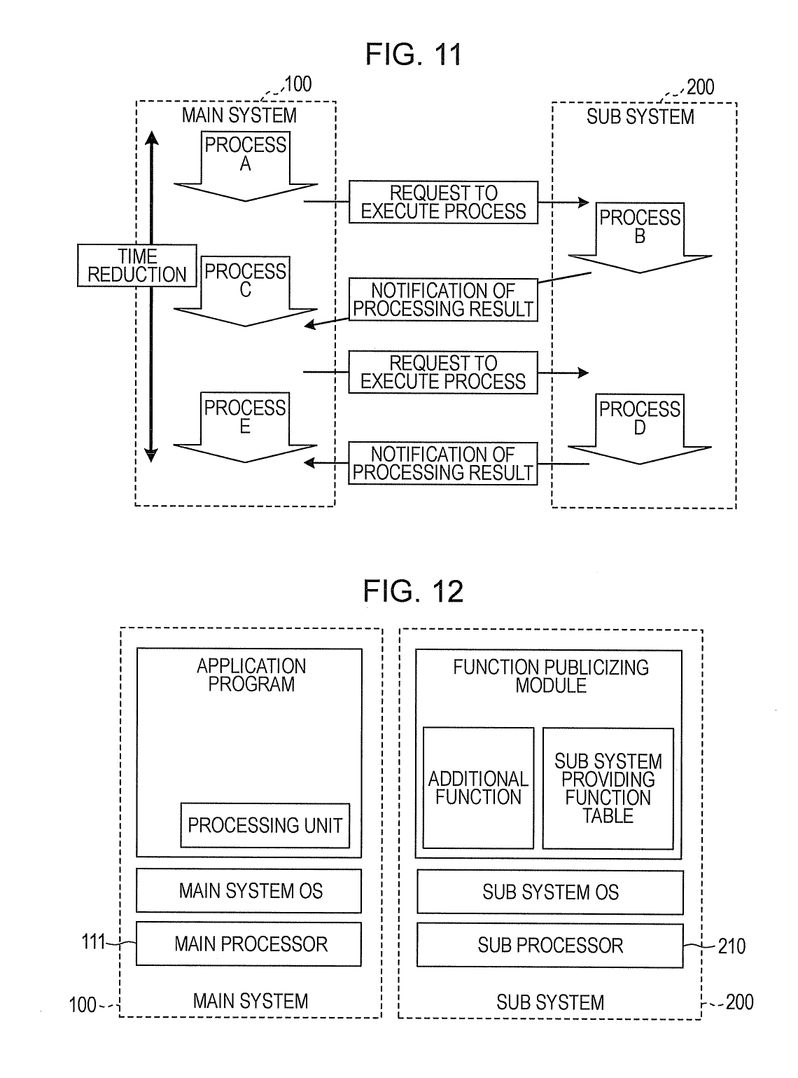

In addition, in the case that execution of part of the processes to be executed on the main system 100 is entrusted to the sub system 200 as illustrated in FIG. 11, processes to be executed on the main system 100 without utilizing a processing result obtained from the sub system 200 are executed in parallel with one another on the main system 100. Owing to the above mentioned operation, the total processing time of the information processing apparatus may be reduced.

That is, according to an embodiment, hardware resources on the sub system 200 may be effectively utilized and the processing time may be reduced by effectively utilizing the hardware resources on the sub system 200.

In addition, in the above mentioned embodiment, functions and data formats used in the sub system 200 corresponding to processes execution of which is to be requested from the main system 100 to the sub system 200 are defined in advance between the main and sub systems. Therefore, execution of a process may be readily requested from the main system 100 to the sub system 200 without working the request for execution of the process given from the main system 100 into a format compatible with the sub system 200 even between systems which are different from each other in architecture. FIGS. 9 to 11 are diagrams illustrating the effects which may be brought about by an embodiment.

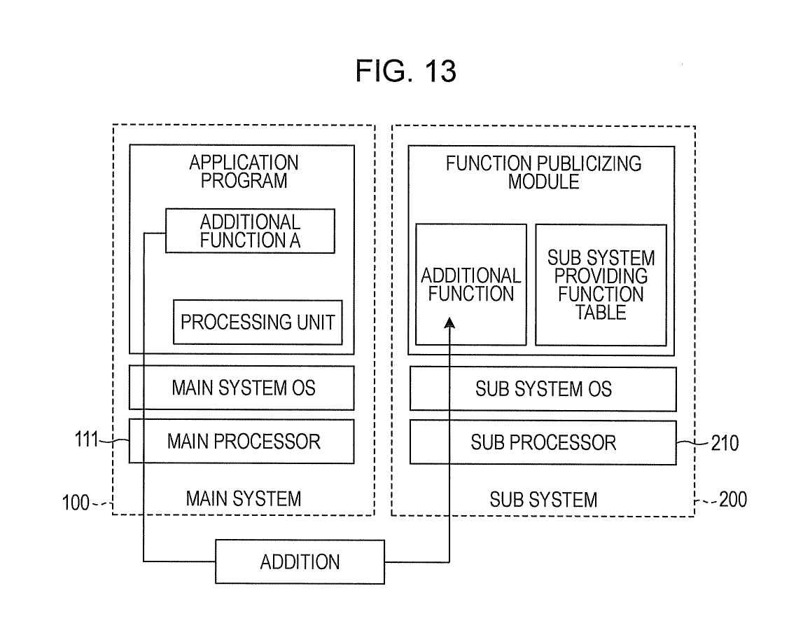

FIG. 12 is a diagram illustrating an information processing apparatus according to an embodiment. The present invention is not limited to the embodiments as described in the above mentioned embodiment and it may be possible to prepare a mechanism of expanding the sub system providing function table, for example, such that execution of a general calculating process may be requested from the main system 100 to the sub system 200.

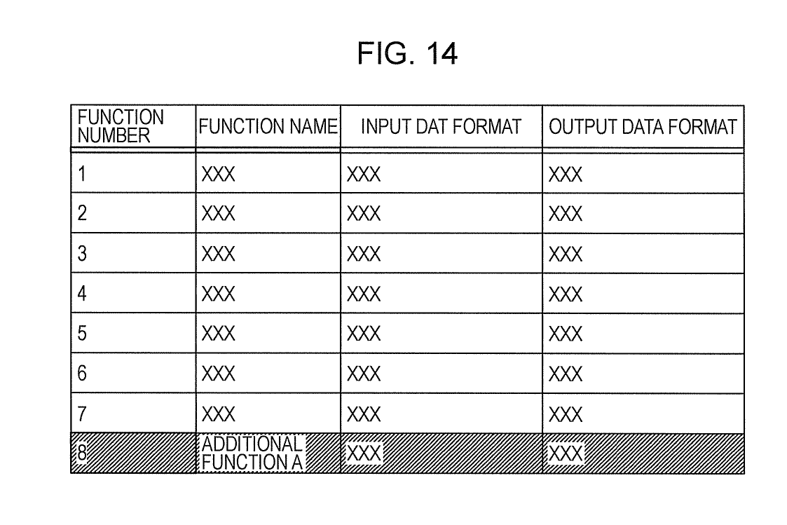

As illustrated in FIG. 13, a program code which may be executed on the sub system 200 is transferred from the main system 100 to the sub system 200 so as to execute the program code on the sub system 200. Then, a function corresponding to a process that the sub system 200 is desired by the main system to newly execute (for example, an additional function A) may be added to the sub system providing function table by utilizing the above mentioned function, for example, as illustrated in FIG. 14. FIG. 13 is a diagram illustrating an information processing apparatus according to an embodiment and FIG. 14 is a diagram illustrating an example of information defined between the main and sub systems of the information processing apparatus according to an embodiment.

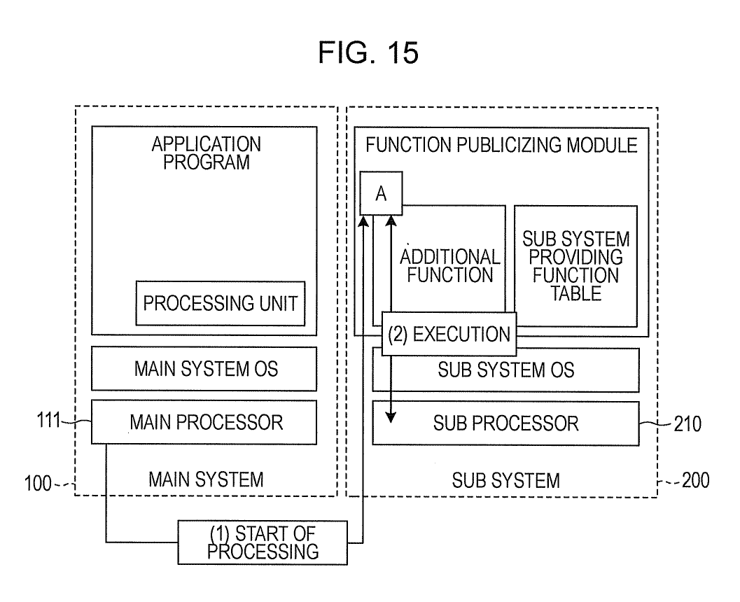

Next, operations performed between the main system and the sub system in the case that a function which has been freshly added to the sub system is utilized will be described. As illustrated in FIG. 15, a request for processing of the additional function A is given from the main system 100 to the sub system 200 as illustrated in FIG. 15 (see (1) in FIG. 15). The additional function A is executed on the sub system 200 (see (2) in FIG. 15).

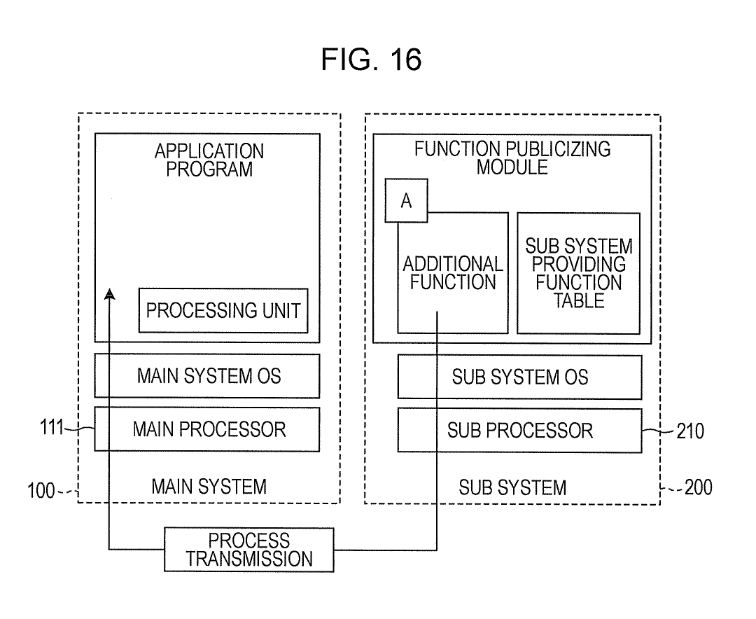

As illustrated in FIG. 16, the sub system 200 transmits a processing result to the main system 100 at the completion of processing of the additional function A. The received processing result is utilized in the application program which is being executed on the main system 100. FIGS. 15 and 16 are diagrams illustrating an information processing apparatus according to an embodiment.

As described above, provision of the mechanism of expanding the sub system providing function table realizes effective utilization of not only a dedicated process such as, for example, a process of using an encryption chip in the sub system 200 but also the resources of the sub processor 210 itself of the sub system 200.

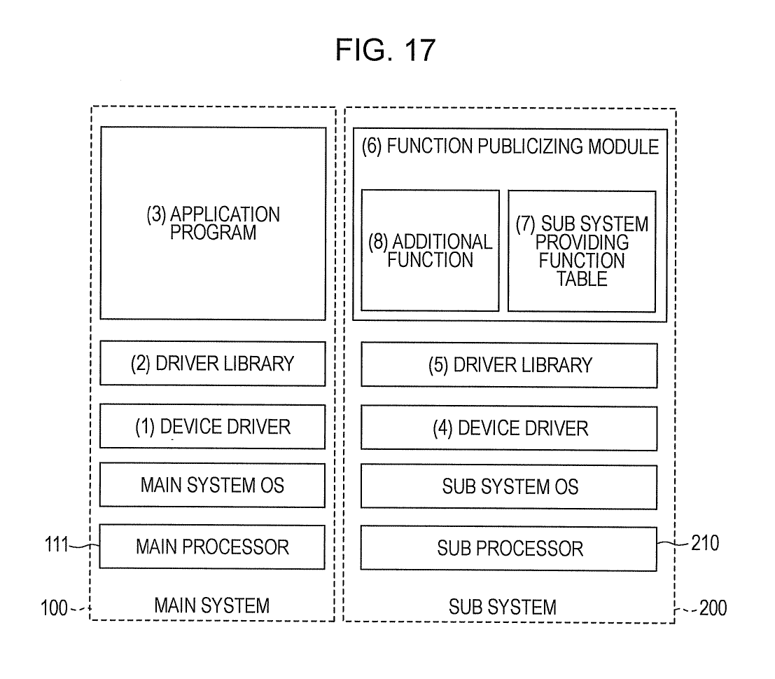

In implementing the embodiments of the above mentioned embodiments, example functions are given as follows with reference to FIG. 17. FIG. 17 is a diagram illustrating examples of functions which will be included in the embodiments. Software is freshly added to the existing hardware with no addition of the hardware resources.

As illustrated in FIG. 17, an application program (see (3) in FIG. 17) used to utilize the sub system 200 from the main system 100 is added to the main system 100. In addition, a device driver ((1) in FIG. 17) which makes it possible to utilize the function of transferring “PROCESSING UNIT” which is data included a function number and the like of a process execution of which is to be requested from the main system 100 to the sub system 200 between the sub controller 112 and the main controller 220 is added. Further, a driver library (see (2) in FIG. 17) having an interface which makes it possible to use the function of the device driver from a user application is added. The device driver function is used to receive a processing result from the sub system 200.

Likewise, as illustrated in FIG. 17, a device driver (see (4) in FIG. 17) which makes it possible to utilize a function of transferring the processing unit which is data included the function number and the like of the process execution of which is to be requested from the main system 100 between the sub controller 112 and the main controller 220 from the function publicizing module (see (6) in FIG. 17) is added to the sub system 200, and a driver library (see (5) in FIG. 17) having an interface which makes it possible to use the function of the above mentioned device driver from the user application is added to the sub system 200. The device driver function is used to receive the processing unit from the main system 100.

In addition, the sub system 200 includes a sub system providing function table (see (7) in FIG. 17) used to specify a processing function corresponding to the function number included in “PROCESSING UNIT” which has been received from the main system 100 and a function publicizing module (see (6) in FIG. 17) used to execute a corresponding process using the resources in the sub system 200 is added to the sub system 200. The above mentioned module also includes a function of transmitting a processing result to the main system 100 and a function of judging whether a request for execution of a process sent from the main system 100 is permitted/refused. The above mentioned module further includes an additional function (see (8) in FIG. 17) of a function corresponding to a process that the main system 100 freshly wishes the sub system 200 to execute.

Next, other embodiments of the information processing apparatus, the information processing method and the information processing program will be described.

The information processing apparatus need not necessarily be physically configured as illustrated in FIG. 3. That is, specific embodiments obtained by distributing and/or integrating the respective devices and constitutional elements of the information processing apparatus are not limited to those illustrated in the FIG. 3 and the information processing apparatus may be configured by distributing and/or integrating all or part of the devices and elements thereof functionally and/or physically in arbitrary units in accordance with various loads exerted and situations in which the apparatus is used, for example, by configuring such that the main system 100 and the sub system 200 are physically integrated into a single architecture. In addition, all or arbitrarily selected part of the respective processing functions executed by the information processing apparatus may be implemented in the form of a CPU and/or a program which is analyzed and executed by a CPU concerned and/or may be implemented in the form of hardware using a wired logic.

An information processing method as described below may be implemented by using the information processing apparatus which has been described in each of the above mentioned embodiments.

That is, an information processing method including the operations of transferring a processing unit which is data included a function number and the like used to specify a processing function on the sub system 200 corresponding to a process which is included in processes to be executed on the main system 100 side and execution of which is to be requested to the sub system 200 from the main system 100 to the sub system 200 (see, for example, operation S4 in FIG. 8) and of transferring a processing result of the process executed by the processing function corresponding to the function number included in the processing unit received from the main system 100 from the sub system 200 to the main system 100 (see, for example, operations S5 and S6 in FIG. 8) may be implemented.

According to an embodiment a method is provided that enables outsourcing of a previously defined function to a subsystem and using a processing result of the function to succeed processes of a main system. The method according to an embodiment allows a new function to be added, and continuing the processes using a processing result of the added function.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An information processing apparatus, comprising:
a main body including a first processing device; and
a system control device including a second processing device for controlling an operation of the main body,
wherein the main body includes:
a function specifying information storage section that stores function specifying information indicating a processing function on the second processing device corresponding to a process which is included in processes to be executed by the first processing device and scheduled to execute that is requested from the first processing device to the second processing device, and
a processing information transfer section for transferring a processing information including the function specifying information stored in the function specifying information storage section to the system control device, and
the system control device includes:
a provided function storage section that stores a processing function corresponding to the process which is included in the processes to be executed by the first processing device and requested to execute from the first processing device to the second processing device as a provided function which is provided to the main body, and
a processing result transfer section that executes the process using the processing function stored in the provided function storage section and corresponding to the function specifying information included in the processing information which has been received from the main body and that transfers a result of execution of the process to the main body.

2. The information processing apparatus according to claim 1, wherein the function specifying information storage section stores the function specifying information with respect to a process which is included in the processes to be executed by the first processing device and a processing time of the first processing device is reduced when executed by the second processing device.

3. The information processing apparatus according to claim 1, wherein the main body includes:
a plurality of first processing devices, and
a parallel processing section that makes the plurality of first processing devices execute the processes to be executed by the first processing devices without utilizing a result of execution of the process execution of which has been entrusted to the second processing device in parallel with one another when execution of part of the processes to be executed by the first processing device is requested to the second processing device.

4. The information processing apparatus according to claim 1, wherein the main body includes;
a provided function adding section that registers a processing function included in processing functions of the second processing device and corresponding to the process to be added into the provided function storage section when adding a process in which execution is requested to the second processing device among the processes to be executed by the first processing device.

5. An information processing method of an information processing apparatus including a main body having a first processing device and a first storage device connected to the first processing device and a system control device having a second processing device for controlling an operation of the main body and a second storage device connected to the second processing device, the method comprising:
reading function specifying information indicating a processing function on the second processing device corresponding to a process which is included in processes to be executed by the first processing device and scheduled to execute that is requested from the first processing device to the second processing device from the first storage device;
transferring a processing information including the read function specifying information from the main body to the system control device by using a processing information transfer section included in the main body;
receiving the processing information transferred from the processing information transfer section by using the system control device;
executing the process using a processing function included in processing functions which are stored as the provided functions and corresponding to the function specifying information included in the received processing information; and transferring a result of execution of the process to the main body.

6. The information processing method according to claim 5, comprising:
registering the function specifying information with respect to a process which is included in the processes to be executed by the first processing device and a processing time is reduced when executed by the second processing device.

7. The information processing method according to claim 5, wherein the main body includes:
a plurality of first processing devices and a parallel processing section, and
the plurality of first processing devices execute the processes to be executed by the first processing devices without utilizing a result of execution of the process execution of which has been entrusted to the second processing device in parallel with one another by using the parallel processing section when execution of part of the processes to be executed by the first processing devices is requested to the second processing device.

8. The information processing method according to claim 5, wherein the main body includes a provided function adding section, and
registering a processing function included in the processing functions of the second processing device and corresponding to the added process into the second storage device as the provided function by using the provided function adding section when a process execution of which is requested to the second processing device is selected from within the processes executed by the first processing device and is added.

9. A computer readable medium including program applied to an information processing apparatus including a main body having a first processing device and a first storage device connected to the first processing device and a system control device having a second processing device for controlling the operations of the main body and a second storage device connected to the second processing device, the program makes the first processing device execute the operations of:
reading function specifying information indicating a processing function on the second processing device corresponding to a process which is included in processes to be executed by the first processing device and scheduled to execute that is requested from the first processing device to the second processing device;
transferring a processing information including the read-out function specifying information from the main body to the system control device by using the processing information transfer section included in the main body, and
making the second processing device execute the operations of:
receiving the processing information transferred from the processing information transfer section by using the system control device;
executing the process using the processing function included in the processing functions which are stored as the provided functions and corresponding to the function specifying information included in the received processing information; and
transferring a result of execution of the process to the main body.

10. The information processing program according to claim 9, making the first processing device execute:
registering of the function specifying information with respect to a process which is included in the processes executed by the first processing device and a processing time is reduced when executed by the second processing device.

11. The information processing program according to claim 9, wherein the main body includes a plurality of the first processing devices and a parallel processing section, and the first processing device causes the plurality of first processing devices to execute the processes executed by the first processing devices without utilizing a result of execution of the process execution of which has been entrusted to the second processing device in parallel with one another by using the parallel processing section when execution of part of the processes to be executed by the first processing devices is requested to the second processing device.

12. The information processing program according to claim 9, wherein the main body includes a provided function adding section, and
the first processing device executes registering of a processing function included in the processing functions of the second processing device and corresponding to the added process as the provided function into the second storage device by using the provided function adding section when a process execution of which is requested to the second processing device is selected from within the processes executed by the first processing device and is added.

13. A computer-implemented method, comprising:
retrieving data defining a function among processes of a main system and transmitting the data to a subsystem; and
succeeding the processes at the main system by utilizing a result received from the sub system due to processing of the function at the subsystem using the data received.

14. The compute-implemented method according to claim 13, comprising:
executing an added function via the subsystem by utilizing data transmitted from the main system, and
continuing said processes at the main system using a processing result of the added function.
